(19) United States
(12) Patent Application Publication
(10) Pub. No.: US 2006/0294277 A1
(43) Pub. Date: Dec. 28, 2006

(54) Message signaled interrupt redirection

(76) Inventor: Raymond Scott Tetrick, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/165,732

(22) Filed: Jun. 24, 2005

(51) Int. Cl. G06F 13/24

(52) U.S. Cl. 710/269

(57) ABSTRACT

A method, device, and system are disclosed. In one embodiment, the method comprises receiving a message signaled interrupt, parsing an interrupt vector from the message signaled interrupt, locating an interrupt entry associated with the interrupt vector in a table of interrupt entries, and sending information associated with the interrupt entry to a processor.

### FIELD OF THE INVENTION

The invention relates to message signaled interrupt redirection. More specifically, the invention relates to using a table of interrupt entries and interrupt redirection to preserve Message Signaled Interrupts (MSI) with new interrupt capabilities.

### BACKGROUND OF THE INVENTION

The PCI Local Bus Specification, Rev. 2.2 (Dec. 18, 1998) introduced the concept of a message signaled interrupt (MSI). An I/O bus-master capable device can request service using an MSI by writing a programmed value to a programmed address. MSI capabilities are present in all PCI Local Bus Specifications in and after Rev. 2.2, and additionally in the PCI Express™ Base Specification 1.0a (Apr. 15, 2003).

Many current Intel® Corporation processors and chipsets utilize MSI capabilities. The IA-32 Intel® Architecture Software Developer's Manual, Vol. 3 (2004) describes the necessary information included in the programmed value that a device must write to perform an MSI in a system with an Intel® Corporation processor or chipset. Two key pieces of information that must be included in the programmed value are the Destination ID (an 8-bit field containing the specific address for the processor or chipset) and the Vector (an 8-bit field containing the interrupt vector associated with the message).

A new extension of an Intel® Processor's integrated interrupt controller (i.e., an Advance Programmable Interrupt Controller) has been proposed to extend interrupt capabilities for Intel® processors. The two primary results of this change are an extension of the number of destinations (i.e., an increase in possible Destination IDs) and a potential increase in the number of Vectors. Unfortunately, as mentioned above, the current Intel® usage model limits the number of Destination IDs and Vectors to 256 each because of the 8-bit field limitation.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of a computer system which may be used with embodiments of the present invention.

FIG. 2 describes one embodiment of the current and new implementations of the MSI programmed value and address in an Intel® processor environment.

FIG. 3 is a flow diagram of one embodiment of a method for redirecting a message signaled interrupt.

### DETAILED DESCRIPTION OF THE INVENTION

Embodiments of a method, device, and system for message signaled interrupt redirection are disclosed. In the following description, numerous specific details are set forth. However, it is understood that embodiments may be practiced without these specific details. In other instances, well-known elements, specifications, and protocols have not been discussed in detail in order to avoid obscuring the present invention.

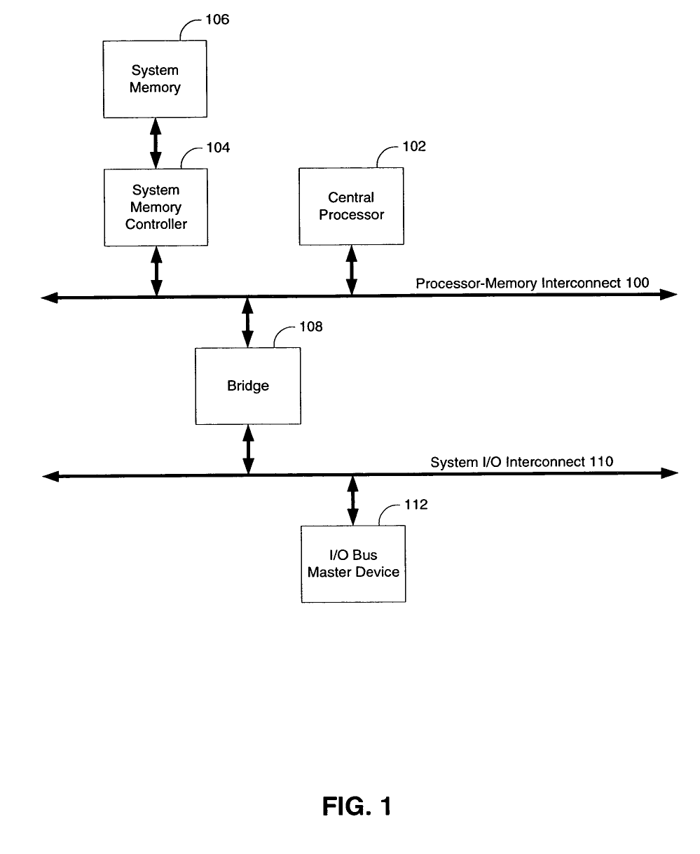

In a computer system that utilizes an Intel® Corporation processor or chipset, the key limitation regarding number of MSI Destination IDs and Vectors is the 8-bit field limitation, as mentioned above, specified in the IA-32 Intel® Architecture Software Developer's Manual, Vol. 3 (2004). In order to circumvent this limitation and extend the Destination ID and the Vector fields, a level of indirection is needed. FIG. 1 is a block diagram of a computer system which may be used with embodiments of the present invention. The computer system comprises processor-memory interconnect 100 for communication between different agents coupled to interconnect 100, such as processors, bridges, memory devices, display devices, etc. Processor-memory interconnect 100 includes specific interconnect lines that send arbitration, address, data, and control information (not shown). In one embodiment, central processor 102 is coupled to processor-memory interconnect 100. In another embodiment, there are multiple central processors coupled to processor-memory interconnect (multiple processors are not shown in this figure).

Processor-memory interconnect 100 provides the central processor 102 access to the memory and input/output (I/O) subsystems. System memory controller 104 is coupled to processor-memory interconnect 100 for controlling access to system memory 106. In one embodiment, the system memory controller is located on the same chip as the central processor (a single chip processor and memory controller is not shown in this figure). Information, instructions, and other data may be stored in system memory 106 for use by central processor 102 as well as many other potential devices. In one embodiment, a device with a graphics processor (not shown) is also coupled to processor-memory interconnect 100. An I/O bus master device 112 is coupled to system I/O interconnect 110 and to processor-memory interconnect 100 through bridge 108. Bridge 108 is coupled to processor-memory interconnect 100 and system I/O interconnect 110 to provide an interface for a device on one interconnect to communicate with a device on the other interconnect.

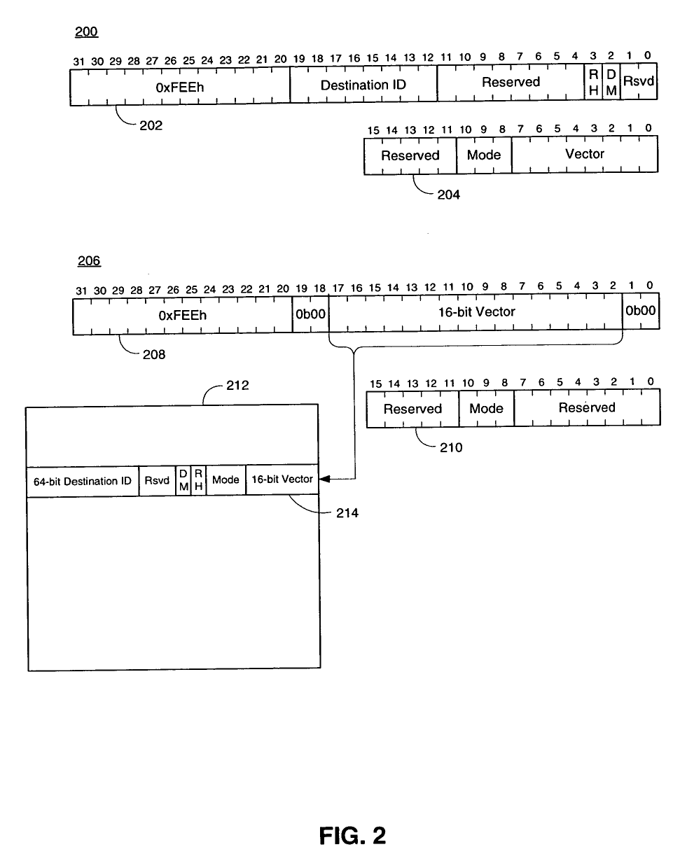

In one embodiment, the I/O interconnect master device generates an MSI by writing a programmed value (referred to as the message data register) to a programmed address (referred to as the message address register). FIG. 2 describes one embodiment of the current and new implementations of the MSI programmed value and address in an Intel® processor environment. One implementation (200) of the programmed address and value include the information as described in the IA-32 Intel® Architecture Software Developer's Manual, Vol. 3 (2004). This current implementation of the programmed address 202 includes an 8-bit Destination ID field (bits 19-12). Additionally, the current implementation of the programmed value 204 includes an 8-bit Vector field (bits 7-0). Although not all bits of information are shown in the message data register value 204, all relevant bits of information are included in FIG. 2.

In one embodiment, the message data register and message address register (206 of the present invention) include a new implementation of the programmed address 208 and the programmed value 210. In this embodiment, the programmed address 208 has a 16-bit Vector field (bits 17-2), which allows for a larger number of vector possibilities (2¹⁶=65536 unique vectors). In one embodiment, the 16-bit vector field acts as an index value into a table of interrupt entries 212. In one embodiment, the table of interrupt entries is placed contiguously in system memory. The individual interrupt entries in the table can be any given uniform length to accommodate all necessary information. Among the information stored in each new interrupt entry 214 is an extended 64-bit Destination ID field.

Thus, when an MSI is generated it is redirected to the table of interrupt entries and the programmed address's 16-bit vector field enables a lookup of the specific interrupt entry being used. The initial redirection to the table may occur in a number of ways. In one embodiment, a bridge (such as bridge 108 in FIG. 1) that receives an MSI has the redirection capability to send the MSI to the table of interrupt entries 212 for lookup. For example, if bridge 108 receives an access request to the 0×FEEh section of memory from I/O interconnect master device 112, the device is sending an interrupt request. Bridge 108 will redirect the interrupt request to a predetermined address in system memory that corresponds with the start of the table of interrupt entries 212. The 16-bit vector field associated with the interrupt would be parsed out of the programmed address value, added to the predetermined starting address of the table, and the specific interrupt entry can then be accessed. Once the interrupt entry is located, the interrupt is sent to the specific target device by using the address in the 64-bit Destination ID field of the interrupt entry. In different embodiments, the target device may be a central processor, a chipset, or any other possible device that can receive and process interrupts.

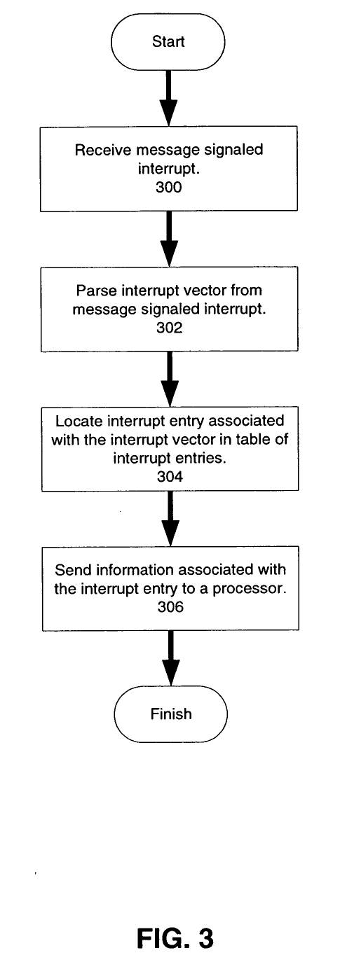

FIG. 3 is a flow diagram of one embodiment of a method for redirecting a message signaled interrupt. The method is performed by processing logic that may comprise hardware (circuitry, dedicated logic, etc.), software (such as is run on a general purpose computer system or a dedicated machine), or a combination of both. Referring to FIG. 3, the method begins by processing logic receiving a message signaled interrupt (block 300). Next, processing logic parses an interrupt vector from the message signaled interrupt (block 302). Then processing logic locates an interrupt entry associated with the interrupt vector in a table of interrupt entries (block 304). Finally, processing logic sends the information associated with the interrupt entry to a processor (block 306) and the process is finished.

Thus, embodiments of a method, device, and system for message signaled interrupt redirection are disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
receiving a message signaled interrupt;
parsing an interrupt vector from the message signaled interrupt;
locating an interrupt entry associated with the interrupt vector in a table of interrupt entries; and
sending information associated with the interrupt entry to a processor.

2. The method of claim 1, wherein the message signaled interrupt further comprises:
message address register contents; and
message data register contents including at least an interrupt vector field.

3. The method of claim 2, wherein parsing an interrupt vector from the message signaled interrupt comprises determining the information contained in the interrupt vector field of the message data register contents.

4. The method of claim 3, wherein the table of interrupt entries comprises a contiguous portion of a memory, wherein at least a portion of each interrupt entry includes a table entry vector.

5. The method of claim 4, wherein locating an interrupt entry associated with the interrupt vector in a table of interrupt entries comprises finding the interrupt entry in the table that has a corresponding table entry vector that matches the interrupt vector.

6. The method of claim 2, wherein the interrupt vector field comprises a 16-bit value.

7. The method of claim 4, wherein the contiguous portion of a memory comprises a contiguous portion of system main memory.

8. An apparatus, comprising:
a memory to store a table of interrupt entries; and
an interrupt redirection unit operable to receive a message signaled interrupt, parse an interrupt vector from the message signaled interrupt, locate an interrupt entry in the table associated with the interrupt vector, and send information associated with the interrupt entry to a processor.

9. The device of claim 8, wherein the message signaled interrupt further comprises:
message address register contents; and
message data register contents including at least an interrupt vector.

10. The device of claim 9, wherein the table of interrupt entries comprises a contiguous portion of a memory, wherein at least a portion of each interrupt entry includes a table entry vector.

11. The device of claim 10, wherein the interrupt redirection unit is further operable to search the table of interrupt entries for a table entry vector that matches the interrupt vector.

12. The device of claim 9, wherein the interrupt vector comprises a 16-bit value.

13. The device of claim 10, wherein the contiguous portion of a memory comprises a contiguous portion of system main memory.

14. A system, comprising:
an interconnect;
a processor coupled to the interconnect;
a network interface card coupled to the interconnect;
memory coupled to the interconnect, the memory to store a table of interrupt entries;
a secondary bus master device coupled to the interconnect, the secondary bus master device operable to send a message signaled interrupt across the interconnect; and
an interrupt redirection unit coupled to the interconnect, the interrupt redirection unit to receive a message signaled interrupt, to parse an interrupt vector from the message signaled interrupt, to locate an interrupt entry in the table associated with the interrupt vector, and to send information associated with the interrupt entry to a processor.

15. The system of claim 14, wherein the message signaled interrupt further comprises:
message address register contents; and
message data register contents including at least an interrupt vector.

16. The system of claim 15, wherein the table of interrupt entries comprises a contiguous portion of a memory, wherein at least a portion of each interrupt entry includes a table entry vector.

17. The system of claim 16, wherein the interrupt redirection unit is further operable to search the table of interrupt entries for a table entry vector that matches the interrupt vector.

18. The system of claim 15, wherein the interrupt vector comprises a 16-bit value.
